(19) United States
(12) Patent Application Publication
(10) Pub. No.: US 2005/0002375 A1
(43) Pub. Date: Jan. 6, 2005

(54) Advanced TDMA resource management architecture

(76) Inventors: Dilip Shyamsundar Gokhale, Montgomery Village, MD (US); Ajai Kaul, Germantown, MD (US); Udayan Narayan Borkar, Sunnyvale, CA (US)

Correspondence Address: ALTIGY LLC, 9700 GREAT SENECA HIGHWAY, ROCKVILLE, MD, 20850, US

(21) Appl. No.: 10/840,387

(22) Filed: May 7, 2004

Related U.S. Application Data
(60) Provisional application No. 60/468,275, filed on May 7, 2003.

(51) Int. Cl. H04B 7/212

(52) U.S. Cl. 370/347

(57) ABSTRACT

This invention relates to a system comprising resource management architecture that meets the requirements of supporting hierarchical SLA based services with QoS commitments in multi-frequency TDMA based wireless environments. Specifically, this architecture provides the capability of allocating resources to an end-user terminal, meeting end-user requirements such as the multitude of traffic classes of service, traffic quality of service, service level commitments, end-user terminal location within the coverage area, and dynamically changing propagation conditions. More specifically, this invention provides a resource management architecture enabling a single end-user terminal to transmit bursts with multiple modulation types, symbol rates, and coding rates within a single TDMA frame

### CROSS-REFERENCE TO RELATED APPLICATIONS

This application claims priority to U.S. Provisional Application Ser. No. 60/468,275, Title “Advanced TDMA resource management architecture” filed on 2003 May 7 and incorporated herein by reference.

### FIELD OF THE INVENTION

This invention relates to computer, satellite, and terrestrial wireless networking, software development, and broadband service. Specifically, the invention relates to a resource management architecture that is capable of supporting hierarchical Service Level Agreements (SLAs) that represent multiple classes of service with specified capacity parameters and service quality commitments in a multi-frequency TDMA based wireless environment.

### BACKGROUND OF THE INVENTION

Time Division Multiple Access (TDMA) is a well-known and frequently-used technique for sharing radio resource capacity among multiple transmitters. Durations of time are divided into frames (a repetition interval) and each frame is further subdivided into slots. The slots can be of variable length depending upon the choice of symbol rates, coding rates, and information lengths that are selected for the specific network. TDMA may be used to provide mesh connectivity between terminals (any-to-any communication), or star connectivity (terminal-to-hub). In this context, there is a central Network Control Center (NCC) that performs allocation of capacity to terminals.

Several strategies to perform allocation of TDMA slots on demand to terminals have been proposed to achieve basic connectivity. These strategies typically deal with the allocation of slots to circuit mode services (slot allocated for the duration of a call) or packet mode services (e.g., VSAT data networks). With the integration of voice, video and data using a common underlying technology such as IP or ATM, the ability to support multiple service classes with Service Level Agreements (SLAs) that provide for capacity (e.g., guaranteed, peak) and quality (e.g., error-rate, delay and delay variance) commitments. Traffic handling priority is another key component for an SLA. This parameter can be used to differentiate application traffic that is sensitive to delay and as such must be allocated resources prior to other traffic. An example of such traffic is “interactive” traffic, the delay performance of which can be immediately perceived by the human end user. Most service providers, as well as subscribers, also need the ability to specify SLAs in a hierarchical fashion, where the available capacity is partitioned by Internet Service Provider (ISP)/Enterprise, by User within ISP/Enterprise, and by Flow/Class-Of-Service/Application within User. To summarize, it is thus critical to have TDMA allocation approaches that support multiple service and quality levels and provide for flexible, hierarchical capacity partitioning.

Newer systems (such as the IEEE 802.16 standard for terrestrial fixed wireless networks and the ETSI defined DVB-RCS standard for satellite networks) may also provide the capability to simultaneously support multiple TDMA slot types in a network. These slot types can correspond to slots of different modulation types, symbol rates, coding types, and coding rates. This feature provides the ability to match a slot-type with traffic taking into account the bit and packet error rate requirements and terminal characteristics (static & dynamic). Static characteristics include RF capabilities (e.g., output power, antenna size, frequency hopping constraints) and location (beam-center or beam-edge). Dynamic characteristics include rain-fade status (especially for terminals that are operating at the higher frequency bands such as Ku, Ka, etc.). For instance, voice traffic may be tolerant of a higher bit error rate and can be allocated slots with lighter coding (fewer error correction bits) as compared to data traffic. As another example (in a satellite network), terminals at the beam-edge could be allocated slots with heavier coding as compared to terminals at the beam-center for the same traffic type.

Another key consideration is the requirement to allocate TDMA slot resources to a large number of end-user terminals and their associated “Flows”. Here, Flow refers to a unidirectional traffic flow that meets certain attributes (e.g., source/destination IP addresses, other classifiers) and is provided specific QoS treatment. An example of this requirement is a satellite network for offering residential broadband services, in which the TDMA slots on a large number of frequency carriers may be shared among tens of thousands of terminals and their Flows.

### SUMMARY OF THE INVENTION

The present invention provides a resource management architecture that meets the requirements of supporting hierarchical Service Level Agreements (SLAs) which guarantee specific QoS commitments, in multi-frequency TDMA-based wireless environments. In one embodiment, the architecture provides the capability of allocating resources in an efficient manner consistent with end-user requirements of a multitude of QoS commitments, end-user terminal location within the wireless or satellite coverage area, and dynamically changing propagation conditions (e.g., rain-fade) applicable to the end-user terminal. The resource management architecture provided herein enables a single end-user terminal to transmit bursts with multiple modulation types, symbol rates, and coding rates within a single TDMA frame. Additionally, it supports both static capacity allocation (corresponding to Users whose traffic characteristics are fixed for the duration of a session like ATM CBR) and dynamic capacity allocation (corresponding to traffic flows that have variable, possibly burst data transfer requirements like ATM UBR and ABR).

The invention describes an approach wherein separate algorithms are provided for capacity allocation and slot allocation to provide hierarchical class and quality based services and to optimize capacity in the context of wireless system constraints (slot types, terminal characteristics, etc.). The capacity-scheduling algorithm takes into consideration the capacity related parameters (e.g., guaranteed and peak rates, traffic handling priority), and the hierarchical partitioning of capacity. The slot-scheduling algorithm takes as inputs the allocations by the capacity scheduler, and then maps these to slots in the TDMA frame taking into consideration constraints vis-à-vis terminal characteristics. These algorithms operate and optimize resources (capacity and slot) independently, however they also interact in some specifically defined manner to attain overall system optimization.

The present invention describes an interaction between a Resource Management Layer (which functions as the central coordinator), a Capacity Scheduling Layer, and a Slot Scheduling Layer. It also provides for procedures that create Capacity Classes corresponding to Users and User-specific Flows and the creation of tree hierarchies via operator configurable databases. An embodiment of the present invention also provides for three phases during periodic scheduling of capacity to users: The guaranteed cycle allocates the minimum capacity that cannot be denied allocation. The excess cycle fairly allocates an equitable distribution of available capacity to eligible entities based on the established SLA agreements. The excess cycle maybe separately invoked for each traffic-handling priority level. Finally, a system-optimizing cycle may be used to generate additional allocations beyond the allocated capacity, and allow the Slot-Scheduling Layer to fully pack the TDMA frame. This cycle takes into account the fact that excess capacity allocations may be blocked due to system and end-user terminal constraints. A feedback loop may also be supported within the architecture whereby the Capacity-Scheduling Layer can take into account the excess and system optimizing capacity allocations that could not be satisfied by the Slot-Scheduling Layer.

### BRIEF DESCRIPTION OF THE DRAWINGS

FIG. 1 depicts an embodiment of the present invention relating to a real-time TDMA resource management system.

FIG. 2 depicts possible components of a proposed Resource Management Architecture, an embodiment of the present invention.

### DETAILED DESCRIPTION OF THE INVENTION

It is to be understood that this invention is not limited to the particular methodologies, protocols, constructs-, algorithms, or components described and as such may vary. It is also to be understood that the terminology used herein is for the purpose of describing particular embodiments only, and is not intended to limit the scope of the present invention.

It must be noted that as used herein and in the appended claims, the singular forms “a,” “and,” and “the” include plural reference unless the context clearly dictates otherwise.

Unless defined otherwise, all technical and scientific terms used herein have the same meaning as commonly understood to one of ordinary skill in the art to which this invention belongs. Although any methods, devices, and materials similar or equivalent to those described herein can be used in the practice or testing of the invention, the preferred methods, devices and materials are now described.

All publications and patents mentioned herein are incorporated herein by reference for the purpose of describing and disclosing, for example, the constructs and methodologies that are described in the publications that might be used in connection with the presently described invention. The publications discussed above and throughout the text are provided solely for their disclosure prior to the filing date of the present application. Nothing herein is to be construed as an admission that the inventor is not entitled to antedate such disclosure by virtue of prior invention.

Definitions of the terms used in the present invention are given below:

ABR—Available Bit Rate: As used herein, ABR is one of ATM forum-defined service categories. In this service type, the network makes the best effort to transfer maximum cells but without an absolute guarantee for the cells delivery. ABR supports variable bit rate data traffic with flow control, a minimum guaranteed data transmission rate, and specified performance parameters. In return for regulating user traffic flow, the network offers minimal cell loss of accepted traffic.

ACQ—Acquisition (Timeslot/Burst): As used herein, this refers to a DVB-RCS specification term to define a timeslot/burst used by RCSTs while performing coarse synchronization during the Return Link Acquisition procedure.

ATM—Asynchronous Transfer Mode: As used herein, ATM refers to a connection-oriented transmission protocol based on a fixed length cell of 53 bytes (including a 5-byte header). It is used for transmission of integrated services, broadband switching and multiplexing with high-performance and cost-effectiveness under certain quality of service guarantees.

AVBDC—Absolute Volume Based Dynamic Capacity: As used herein, AVBDC is a DVB-RCS specification term for a dynamic capacity request type used for traffic that can tolerate delay jitter, such as the UBR class of ATM traffic or best effort IP traffic. AVBDC has an associated parameter that indicates the desired absolute volume (in multiples of payload size).

BER—Bit Error Rate: As used herein, BER means the ratio of bits that have errors relative to the total number of bits received in a transmission.

Capacity Class: In the context of an embodiment of the resource management architecture, a Capacity Class corresponds to an entity for which specific capacity guarantees are to be provided. It is associated with guaranteed and maximum capacity parameters, as well as a relative weighting vis-à-vis its siblings.

Capacity Tree: In the context of a resource management architecture embodied in this invention, a Capacity Tree corresponds to a hierarchy of Capacity Classes, where each Capacity Class can either be an Interior Class or a Leaf Class.

C-band: As used herein, C-band refers to satellite communications frequency band with uplink (5.85-6.65 GHz)/downlink (3.4-4.2 GHz).

CBR—Constant Bit Rate: In the context of the present invention, CBR is one of the ATM classes of service, which supports the transmission of a continuous bit-stream of information, such as voice and video traffic, which require a constant amount of bandwidth allocated to a connection for the duration of the transmission.

CRR—Continuous Rate Request: As used herein, a continuous rate request corresponds to a pre-configured request from a terminal expressed in bits per second that is valid for the entire duration of the terminal's session.

CSC—Common Signaling Channel (Timeslot/Burst): As used herein, CSC refers to a DVB-RCS specification term that defines a timeslot/burst used by RCSTs to logon to the network during the Return Link Acquisition procedure.

CSL—Capacity Scheduling Layer: In the context of the present invention relating to the resource management architecture, CSL is responsible for the hierarchical scheduling of capacity based on the active flows and the requests that have been asynchronously received from the user terminals.

DRR—Dynamic Rate Request: As used herein, a dynamic rate request corresponds to a TDMA Capacity Request from a terminal expressed in bits per second that is valid for a specified duration.

DVR—Dynamic Volume Request: As used herein, a dynamic volume request corresponds to a TDMA Capacity Request from a terminal expressed in bits.

Flow: As used herein, Flow means a unidirectional traffic flow that meets certain attributes (e.g., source/destination IP addresses, other classifiers) and is provided specific QoS treatment.

Interior Class: As used herein, interior class refers to a Capacity Class that has one or more descendants.

Jitter: As used herein, jitter relates to the delay variance in transferring a packet across a network.

Ka-band: This term refers to satellite communications frequency band with uplink (27.5-30.0 GHz)/downlink (18.5-21.0 GHz).

Ku-band: This term refers to satellite communications frequency band with uplink (12.75-14.5 GHz)/downlink (10.7-12.75 GHz).

Leaf Class: As used herein, this term refers to a Capacity Class that has no descendants.

Modulation: In the context of the present invention, modulation is the process of manipulating the frequency, phase or amplitude of a carrier in relation to an incoming input signal.

QoS—Quality of Service: As used herein, QoS is the collection of capacity (e.g., guaranteed and peak rates) and quality (e.g., bit error rate, delay, etc) attributes associated with a specific service. This definition of QoS is similar to the usage in 3GPP networks (ETSI 3GPP 23.107).

RADIUS—Remote Authentication Dial-In User Service: As used herein, RADIUS is a client/server protocol that enables remote access servers to communicate with a central server to authenticate dial-in users and authorize their access to the requested system or service.

Rain-fade: This term refers to a phenomenon with higher frequency band satellite and terrestrial wireless communication systems where rainfall can significantly degrade the power level of the transmitted signal.

RBDC—Rate Based Dynamic Capacity: As used herein, RBDC is a DVB-RCS specification term for a dynamic capacity request type used for variable rate traffic. RBDC has an associated parameter that indicates the desired rate (in multiples of 2 Kbit/s).

RCST—Return Channel Satellite Terminal: As used herein, RCST is a user terminal for the reception and transmission of information via satellite. RCST is typically used in conjunction with systems capable of transmitting or receiving in Ku- or Ka-band, and is a generic term encompassing Very Small Aperture Terminals (VSATs), Satellite Interactive Terminals (SITs) and Satellite User Terminals (SUTs).

RML—Resource Management Layer: In the context of the present invention relating to resource management architecture, the RML is the central coordinator for all resource management functions. It coordinates the setup and teardown of flows, and the mapping of capacity requests to specific resource classifiers. It is also responsible for the coordinated scheduling of the capacity and slots on TDMA frame boundaries.

Root Class: In the context of the present invention, the Root Class of a Capacity Tree for a Slot-Pool represents the current aggregate capacity in the Slot-Pool. All other Capacity Classes are descendants of the Root Class.

SLA—Service Level Agreement: As used herein, SLA is a contract in which a service provider specifies service levels and terms under which a service or a package of services is provided to the customer.

Slot-Pool: In the context of the present invention providing for a resource management architecture, a Slot-Pool is a system specific subset of resources (e.g., TDMA slots). Each Slot-Pool consists of slots with the same modulation type, symbol rate, coding type and coding rate, but potentially with a mix of information content lengths.

SNMP—Simple Network Management Protocol: This term refers to a widely used network management protocol.

SSL—Slot Scheduling Layer: As used herein, the SSL is responsible for efficient packing of capacity allocations into TDMA slots.

SYNC-Synchronization (Burst): As used herein, it is a DVB-RCS specification term to define a timeslot/burst used by RCSTs while performing fine synchronization in the Return Link Acquisition procedure and for maintaining synchronization on a periodic basis.

TDMA—Time Division Multiple Access: This term refers to a frequently used technique for sharing radio resource capacity among multiple transmitters. Durations of time are divided into frames (a repetition interval) and each frame is further subdivided into slots.

User: As used herein, user refers to a terminal or an end-user connected to a terminal.

VBDC—Volume Based Dynamic Capacity: As used herein, this is a DVB-RCS specification term for a dynamic capacity request type used for traffic that can tolerate delay jitter, such as the UBR class of ATM traffic or best effort IP traffic. It has an associated parameter that indicates the desired incremental volume (in multiples of payload size).

UBR—Unspecified Bit Rate: As used herein, UBR is one of ATM forum defined service categories that does not specify traffic related service guarantees.

VBR—Variable Bit Rate: As used herein, this term refers to one of ATM forum defined service categories. VBR is divided into non-real-time VBR and real-time VBR. Non-Real-time VBR is delay tolerant and is well suited for bursty traffic such as data communications. Real-time VBR, on the other hand, is suitable for carrying delay sensitive traffic such as packetized video and audio.

VSAT—Very Small Aperture Terminal: This term refers to small profile satellite earth stations, usually in the range of about sub-meter to 2.4 meter.

Additional acronyms used in the present invention are listed below:
CRA CONSTANT RATE ASSIGNMENT
DVB-RCS DIGITAL VIDEO BROADCAST-RETURN CHANNEL OVER SATELLITE
ETSI EUROPEAN TELECOMMUNICATIONS STANDARDS INSTITUTE
IEEE INSTITUTE OF ELECTRICAL AND ELECTRONICS ENGINEERS
IP INTERNET PROTOCOL
ISP INTERNET SERVICE PROVIDER
MF-TDMA MULTI-FREQUENCY TIME DIVISION MULTIPLE ACCESS
NCC NETWORK CONTROL CENTER
RF RADIO FREQUENCY

By way of a brief overview, the architecture reflected in an embodiment of the invention is based on an approach that uses separate algorithms for capacity allocation and slot allocation. Capacity allocation is a decision to allocate capacity in number of bits for every TDMA frame. Slot allocation, on the other hand, is a decision to allocate specific TDMA slots that correspond to a specific modulation type, symbol rate, coding rate, etc. The architecture recognizes that providing hierarchical based QoS services and optimizing capacity in the context of wireless system constraints (slot types, terminal characteristics, etc.) should be accomplished in two separate steps. The capacity scheduling algorithm takes into consideration the capacity related parameters (e.g., guaranteed and peak rates) and hierarchical partitioning of capacity. The slot scheduling algorithm, takes as inputs the allocations by the capacity scheduler. It then maps these allocations to slots in the TDMA frame taking into consideration constraints vis-à-vis terminal characteristics. While operating and optimizing resources (capacity & slot) independently, these algorithms interact in a manner that results in overall system optimization.

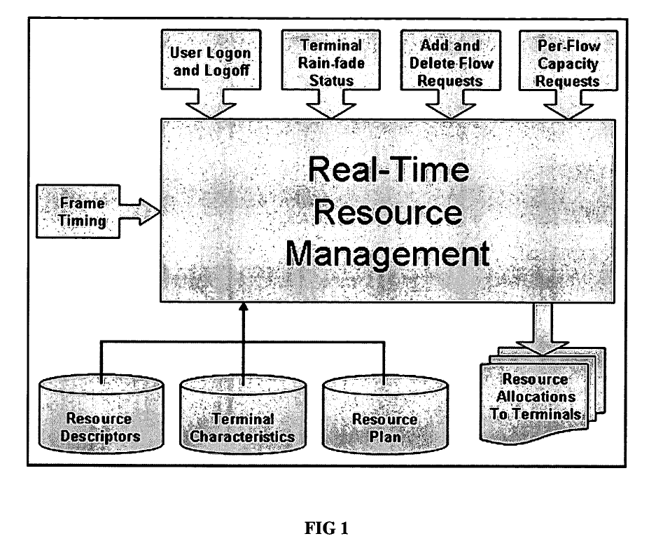

For example, FIG. 1 depicts an embodiment of the present invention relating to a real-time TDMA resource management system. As seen in the Figure, the inputs to the Resource Management function consist of requests to setup and teardown Flows, dynamic capacity requests, User logon/logoff, and changes to terminal rain-fade characteristics. The function is also provided with configuration parameters such as resource descriptors and radio resource plans. Additionally, the management system receives a timing signal that may designate the TDMA frame boundary. Not all inputs may be present in certain systems. For instance, there may not be a requirement for getting rain-fade status if the wireless network is operating at lower frequency bands (e.g., C-band). The output corresponds to the TDMA slot assignments for terminals in the network.

The resource management architecture proposed in an embodiment of the invention manages radio resources in the form of Slot-Pools. A Slot-Pool is a system-specific subset of resources (e.g., TDMA slots). Each Slot-Pool consists of slots with the same modulation type, symbol rate, coding type and coding rate, but potentially with a mix of information content lengths. The need for multiple slot types and Slot-Pools arises from the requirements to support different bit and packet error rates while taking into account terminal RF characteristics. For instance, different types of slots may be desirable for different QoS classes. For instance, conversational services (voice) may be tolerant of a higher bit error rate while data is typically less tolerant of bit errors. Therefore, the voice service may be allocated slots from a Slot-Pool with lighter coding (less number of error correcting bits). Multiple Slot-Pools may also be used to compensate for differences in terminal location within the coverage area. Signals transmitted from terminals at the edge of the beam experience greater propagation losses than those transmitted by terminals at the center of the beam. Therefore, slots from different Slot-Pools could be used for these two cases. Similarly, terminals with smaller antennae or power amplifiers transmit signals with less power. Therefore, these terminals may be allocated slots with lower symbol rates and coding rates as compared to other terminals. Multiple slot-types also support rain-fade compensation in the higher frequency bands. A Slot-Pool consisting of slots with lower symbol rate/higher coding rate may be set aside for terminals that experience rain-fade.

The resource management architecture proposed in an embodiment of the invention supports QoS contracts for: (a) Flow—Unidirectional traffic flow that meets certain attributes (e.g., source/destination IP addresses, other classifiers) and is identifiable as such by the network; (b) User—Refers to a terminal or an end-user connected to a terminal (for example, this architecture may support multiple end-users behind a single terminal that, for example, can belong to different ISPs); and/or (c) Cluster—Generic term used to designate the collection of Users (e.g., end-users belonging to a specific ISP or Enterprise). The resource management architecture provided herein is designed to partition the capacity in a hierarchical manner. For example the overall capacity may be first divided among Clusters, then to a specific User within the Cluster and finally to specific Flows for the User. The architecture described herein also allows for additional definition of hierarchies at levels above the Cluster level.

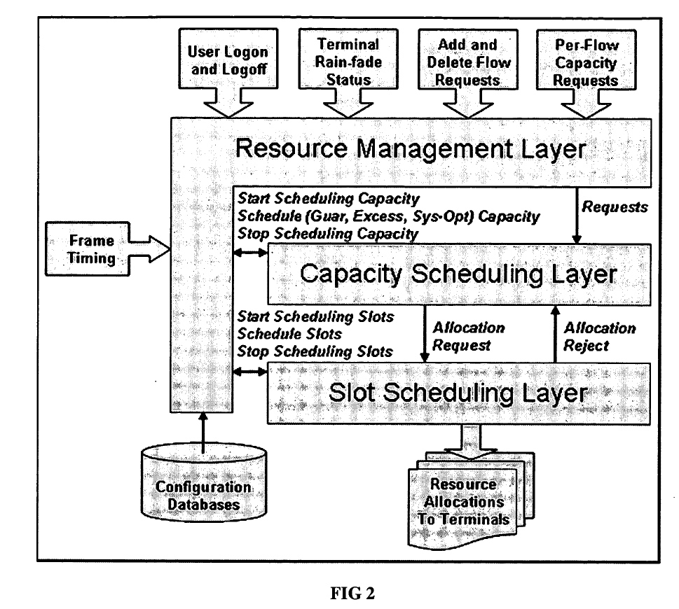

Referring now in more detail to the Resource Management Architecture, as provided herein this may be embodied as shown in FIG. 2. This proposed architecture consists of three layers, namely, a Resource Management Layer (RML), a Capacity Scheduling Layer (CSL), and a Slot Scheduling Layer (SSL).

RML, which serves as the central coordinator for the proposed resource management architecture, represents procedures to map end-user traffic requirements to specific Slot-Pools and Capacity Classes and is responsible for the overall scheduling of the capacity and slot allocation algorithms. More specifically, it is responsible for the following: (a) Implementing policies to allocate capacity between various entities such as Clusters, Users, Classes of Service and Applications; (b) Setting up and tearing down Flows, where each Flow can be associated with specific service level parameters and is mapped to a specific Slot-Pool and CSL classifier (i.e., Capacity Class discussed later) based on QoS Parameters (e.g., BER), terminal static characteristics (e.g., output power, antenna, location, etc.), terminal rain-fade status, and/or other constraints & policies; (c) Mapping a received capacity request to a CSL classifier; (d) Invoking capacity and slot scheduling on a TDMA frame boundary. Additionally, RML also handles creation and deletion of Capacity Classes. As part of adding a new Capacity Class, RML also checks the feasibility of supporting its guaranteed capacity requirement with the SSL algorithm.

In an embodiment of the proposed resource management architecture, CSL (one per Slot-Pool) can be system independent and is responsible for the hierarchical QoS-based allocation of capacity. It offers the capability of configurable hierarchical partitioning of capacity by Cluster, by User, by CoS/Application and provides the ability to offer SLAs at various levels of the hierarchy. CSL creates a Capacity Tree corresponding to a hierarchy of Capacity Classes for every Slot-Pool. The Root Capacity Class represents the total capacity of the Slot-Pool. A Capacity Class corresponds to an entity (e.g., Cluster, User or Flow) for which specific capacity guarantees are to be provided. It is associated with guaranteed and maximum capacity parameters as well as a relative weighting vis-à-vis its siblings. Each Capacity Class can either be an Interior Class or a Leaf Class. If a Class has no descendants, it is termed a Leaf Class; otherwise it is regarded as an Interior Class. Leaf Classes correspond to User Flows and are also associated with a Priority Level. Each Capacity Class has parameters that define the SLA for the entity represented by the Capacity Class. On every TDMA frame boundary, CSL performs allocations in accordance with the parameters of the Capacity Classes and the requests that are received from the terminals. CSL is responsible for “auto-generating” requests for provisioned constant rate Flows for which there may normally be no requests from the terminal. Flows that are provisioned with a guaranteed capacity component are assured of receiving the said allocation in each frame. Left-over capacity (i.e., capacity remaining in excess of all guaranteed capacity) is then allocated in an equitable prioritized manner. The use of Priority ensures that the system is capable of giving precedence or preference to the allocation of excess capacity to specific traffic types (e.g., interactive). The CSL is also responsible for taking into account the required delay variance in making decisions regarding the allocation of both guaranteed and excess capacity.

In another embodiment of the present invention, SSL is typically system-specific and provides for the optimal allocation of slots in a TDMA frame. The main function of SSL is to schedule time-slots within a TDMA frame taking as input guaranteed and weighted excess capacity allocations from one or more CSLs. Additionally, this layer takes into account physical layer constraints such as modulation, symbol rates, coding rates, and terminal frequency hopping constraints and attempts to optimize allocation of slots. SSL is responsible for making allocation of slots across all Slot-Pools (if there are multiple Slot-Pools). It can also perform functions such as combining multiple capacity allocation requests into a single slot assignment to improve overall efficiency (i.e., minimize pre-amble, post-amble, and guard time) when the slots in the Slot-Pool have multiple information lengths. SSL is designed to optionally maintain a “contingency” slot-schedule that ensures the scheduling of all guaranteed User-specific capacity allocations. This contingency slot-schedule is checked and updated to accommodate the guaranteed portion of every new User-specific Capacity Class that is added by RML. In the normal mode, SSL attempts to schedule the guaranteed and excess capacity allocations in an optimal manner. If it is unable to schedule all the User-specific and User Flow-specific guaranteed capacity allocations, it starts with the contingency slot-schedule as the baseline and next schedules the excess allocations.

It should be noted, as an aspect of the invention, that capacity requests are received asynchronously while resources are allocated in a synchronized manner. The synchronized allocation of capacity is performed even if the system allows for immediate responses to capacity requests. Capacity requests can either indicate a desired rate (in bits/sec), or desired volume (in bits). Volume requests can either specify incremental requirements (since the last volume request) or absolute requirements. A request may also specify the maximum time by which the request must be satisfied (for the allocation to be useful for the requestor). Capacity scheduling is invoked in three phases: guaranteed (or minimum), excess, and system-optimizing. The guaranteed cycle allocates the minimum capacity that is provisioned for a Capacity Class and cannot be denied allocation. The excess cycle fairly allocates an equitable distribution of available capacity to eligible Classes based on the established capacity agreements. The excess cycle takes into consideration the system traffic handling priority levels and their associated weights. Finally, the system-optimizing cycle generates additional allocations beyond the Slot-Pool capacity, and allows SSL to fully pack the TDMA frame. This cycle takes into account the fact that excess capacity allocations may be blocked due to system and end-user terminal constraints.

Because the scheduling takes place on synchronized boundaries, the processing overhead may be reduced significantly and allows an algorithm to easily scale to support a very large number of simultaneous Flows (tens of thousands). It should be noted that depending upon delay requirements (for the time lag between the request arrival and the allocation being sent), it is possible to invoke the scheduling cycle on sub-frame boundaries (subject to the constraints of the specific system).

In another embodiment of the invention, the resource management architecture may support systems where the frame composition can be dynamically varied (i.e., where the composition of time-slots can change dynamically on a frame-by-frame basis). This is the case in systems such as IEEE 802.16. For such systems, a background algorithm can modify the capacity that is “logically” allocated to each Slot-Pool. In computing the capacity value, the algorithm may take into consideration the current demand from all Slot-Pools. The modification to Slot-Pool allocated capacity can be done at a slower rate (e.g., every 10 seconds) or could be done on a frame-by-frame basis. The algorithm can ensure that the guaranteed or minimum capacity requirements that have been committed to Users and User-specific Flows in each Slot-Pool are always met.

To apply an embodiment of the resource management architecture to an ETSI DVB-RCS satellite network, mapping is maintained on a per Return Channel Satellite Terminal (RCST) basis. It transforms an RCST's Group Id, Logon Id, and the Channel Id received in incoming capacity requests, to a User Id and Request Id. This method allows capacity parameters to be defined for end-users, end-user Flows, RCST, and RCST Flows.

Note that the present invention is not narrowed to a particular approach for capacity scheduling and slot scheduling. Indeed, the invention herein provides the capability for the relatively independent selection and evolution of the CSL and SSL algorithms. The present invention provides for architecture with specific goals that may be achieved using algorithms.

One aspect of the present invention provides for a possible design approach for RML within the proposed resource management architecture. In this aspect of the invention, an internal “Resource Descriptor” database is used to instantiate the Capacity Classes that need to be provisioned. For example, each entry in this database can be identified by Cluster, User and Flow, where User and Flow can be designated as Default. Each entry lists the QoS parameters associated with the Class, as well as the identifier for the Slot-Pool in which the resources are to be allocated. It also contains a unique Request Id that is used to distinguish between dynamically received capacity requests from a User. This Request Id is used to map incoming capacity requests to a specific Leaf Class. The resource descriptor also contains the RF characteristics of the terminal associated with the User.

RML also maintains a “Request Cache”. that provides an efficient means of mapping <User Id, Request Id> to the corresponding Leaf Class. When a capacity request is received, this cache can be used for fast access of the relevant Capacity Class to which the incoming request is attached.

The following describes some possible, non-limiting, steps that may be taken, not necessarily in the given order, to design RML. Though the design steps outlined below refer to a three-level hierarchy (e.g., Cluster, User, and Flow) for the Capacity Tree, they do not serve to limit the scope of the invention described herein.

Initialization: In this aspect of the present invention, an initialization phase may be envisioned as the first step in the RML design approach. This phase includes, for example, creation of a Capacity Tree within each Slot-Pool. Each Capacity Tree thus created includes the addition of a Root Class and also Capacity Classes corresponding to all provisioned Clusters present in the Resource Descriptor database. Associated with the Capacity Tree, among other things, is the per-TDMA frame capacity of the Slot-Pool, the number of traffic handling priority levels that are being used in the Slot-Pool and the weights associated with these levels. The weight for a traffic handling priority level is used to determine the share of excess capacity set aside for all Capacity Classes at that level. To support Users with no explicit provisioned capacity requirements, a Default User Class and a Default Flow Class are automatically created when a Cluster is provisioned. A Default Class is always allocated capacity equal to the difference between the capacity provisioned to its parent and the sum of provisioned capacity of all its siblings. Cluster-specific Flow records can also be added under each Capacity Tree as part of this step. In this case, a Flow Capacity Class is created as a child of the Default User Class.

User Logon: The present invention provides for RML to add a User and its associated Flows to the system when it logs on to the network. For the case where a specific User record descriptor is present, RML performs admission control to determine whether the desired capacity parameters can be satisfied. If so, a Capacity Class for the User is created as a child of the Capacity Class corresponding to its parent Cluster. A Default Flow Class for the User is also created at this time and the Request Cache is updated to point to this Default Flow Class. Capacity Classes are also created for Flows of the User (if they are configured in the Resource Descriptor table) and the Request Cache is updated to reference these Capacity Classes. For User-specific Flows which are provisioned with a “Permanent” request type (e.g., Continuous Rate Assignment or CRA), a capacity request with the associated capacity parameters is automatically generated and attached to the corresponding Flow Class. This request is treated as perpetual as long as the User remains active. On the addition of a User for whom no User or User-specific Flow records exist in the Resource descriptor database, the Request Cache is updated to reference the Default-flow from theUser to the Default Flow Class under the Default User Class for the parent Cluster.

Flow Addition: One facet of the present invention provides for the addition of a Flow corresponding to a particular Resource Descriptor. In order to add a User-specific Flow record, RML performs admission control to determine whether the desired capacity parameters can be satisfied. If so, a User Capacity Class is created as a child of the Class corresponding to the User's Cluster (if no User-specific Class has been created previously). If a Capacity Class for the parent User already exists, a Capacity Class for the User-specific Flow is created as a child of this User Class. If no User-specific Class has been created previously, it is created as a child of the User's parent Cluster Class before creating its Flow Class. As described earlier, if User-specific Flows are provisioned with a “Permanent” request type, a capacity request with the associated capacity parameters is automatically generated and attached to the corresponding Flow Class.

Capacity Request Processing: In an aspect of the present invention, when RML receives a capacity request, it locates the relevant Flow Class by looking up the Request Cache. After It attaches the incoming capacity request to this Flow Class

Terminal Rain-fade Handling: In one aspect of the present invention, RML re-synchronizes its resource descriptors to map to different Slot-Pools and Classes based on changes to propagation environment (e.g., rain-fade in satellite environment). On the receipt of a change in rain-fade status for a terminal, RML deletes all entries from the current Slot-Pool for the corresponding Users and their Flows (if provisioned). It updates the said terminal's RF characteristics to reflect the change in its rain-fade status. It then attempts to create alternative Capacity Classes in a different Slot-Pool (if configured in the resource descriptor database). It also updates the Request Cache to point to the new Capacity Classes. If a User-specific resource descriptor cannot be added, the system could logoff the User. Similarly, if no Users can be handled, the system may logoff the said terminal.

Resource Allocation Scheduling: The periodicity over which scheduling is performed is referred to as “Scheduling-Interval”, which typically corresponds to the duration of one TDMA frame. One embodiment of the present invention provides for RML to perform resource allocation scheduling on every Scheduling Interval in accordance with the at least one of the following steps:

Perform initialization steps in order to start slot scheduling.

Prepare the Capacity Tree associated with each Slot-Pool for the start of a capacity scheduling cycle.

For the Capacity Tree associated with each Slot-Pool, schedule guaranteed capacity.

For the Capacity Tree associated with each Slot-Pool, schedule excess capacity.

For the Capacity Tree associated with each Slot-Pool, schedule system-optimizing capacity.

Carry out slot scheduling by taking as inputs capacity allocations from the CSLs.

For the Capacity Tree associated with each Slot-Pool, perform all CSL cleanup activities including handling feedback from SSL.

Stop slot scheduling activity.

Optionally, some CSL/SSL implementations could combine the Start/Stop Scheduling steps with the Scheduling step.

Flow Deletion: In another aspect of the present invention, when a Flow corresponding to a particular Resource Descriptor is to be deleted, RML determines the Capacity Class (from the Request Cache) and the parent User Capacity Class for the said Flow. After deleting the Flow Capacity Class, if it is found that the parent User is not a provisioned or “Pre-Configured” User (i.e. it is of type “Auto-Increment”) and the only remaining flow for the user is the default flow, then the said User is also deleted.

User Logoff: The present invention provides for RML to take certain steps when a User logs off the network, which involve at a minimum, deleting all the Flows for the said User and clearing entries in the Request Cache corresponding to the said User.

### EXAMPLES

The following examples are for illustrative purposes and do not serve to limit the scope of the invention described herein.

### Example 1

An embodiment of the invention described herein is presented below, illustrating key elements of the resource management architecture and providing a sample design approach for the Resource Management Layer. This example provides a description of possible external and internal interfaces, data structures and definitions, and functions and utility routines used in a specific RML implementation of the invention.

(A) Interfaces

This section describes the internal and external interfaces involved in the RML design approach, namely:

(a) RML External Interface

(b) CSL Interface to RML

(c) SSL Interface to RML

(d) SSL Interface to CSL

(e) SSL External Interface

A detailed description of these interfaces is provided below.

(a) RML External Interface

The external interface primitives to RML are defined in a generic manner. Some of these messages may be generated internally at the NCC by other functions (e.g., Rain-fade Manager). For other messages (e.g., Capacity Request) “system-specific” mapping of actual messages is anticipated. Possible RML external interfaces are as follows:

RMLUserLogon—Indicates that a specified User has joined the network. Triggers the activation of provisioned resources for the User and possibly Flows of the User.

RMLUserLogoff—Indicates that a specified User has logged off the network. Used as a trigger to de-activate any resources that have been provisioned for the User.

RMLAddFlow—Used for the dynamic addition of a Flow for a User.

RMLDeleteFlow—Used for the deletion of a Flow for a User.

RMLCapacityRequest—Capacity request for a specific Flow within a User or for the User (all Flows).

RMLTermRainFadeChange—Received from a terminal, indicating a change in the rain-fade status associated with the terminal. This will affect all Users and their Flows associated with this terminal.

RMLSchedulingIntervalSignal—Used to indicate the start of the next allocation cycle. Triggers capacity and slot scheduling.

(b) CSL Interface to RML

This defines the functions that may be provided by CSL for use by RML, as follows:

CSLCreateCapacityTree—Creates the Capacity Tree for a Slot-Pool.

CSLAddCapacityClass—Adds the specified Capacity Class to a Tree.

CSLDeleteCapacityClass—Deletes the specified Capacity Class from a Tree.

CSLIsCapacityAvail—Checks if the configured capacity of this Class can accommodate the capacity requirements of an additional child.

CSLAddCapacityRequest—Attaches Capacity Request to the specified Leaf Class.

CSLDeleteCapacityRequest—Deletes a Capacity Request from a specified Leaf Class.

CSLStartSchedulingCycle—Performs initialization for the next CSL Scheduling Cycle.

CSLScheduleGuaranteedCapacity—Schedules Guaranteed (or minimum) Capacity for the specified Tree in the next Scheduling Cycle.

CSLScheduleExcessCapacity—Schedules Excess Capacity for the specified Tree for the next Scheduling Cycle.

CSLScheduleSystemOptimizingCapacity—Schedules Additional Capacity for the specified Tree to provide additional allocations (beyond Slot-Pool capacity) to SSL.

CSLStopSchedulingCycle—Performs all CSL cleanup activity including handling feedback from SSL.

Note that certain CSL algorithms may prefer to internally combine certain steps such as “Schedule Excess Capacity” and “Schedule System-Optimizing Capacity”. Similarly, the “Start Scheduling”, “Schedule”, and “Stop Scheduling” primitives could be internally combined for specific CSL algorithms.

(c) SSL Interface to RML

This defines the functions that may be provided by SSL for use by RML, as follows:

SSLStartSchedulingCycle—Performs initialization for the next SSL Scheduling Cycle.

SSLScheduleSlotCycle—Invoked for scheduling the slots on the next TDMA frame.

SSLStopSchedulingCycle—Performs any cleanup activities and signifies the end of the Scheduling Cycle.

SSLIncrGuarTermCap—Request to increment allocated guaranteed capacity for the terminal. SSL checks if the guaranteed (minimum) capacity increment can be satisfied (subject to existing allocations and terminal RF constraints). Returns Success/Failure depending upon the outcome.

SSLDecrGuarTermCap—Request to decrement allocated guaranteed capacity for terminal.

As is the case with CSL, the “Start Scheduling”, “Schedule”, and “Stop Scheduling” primitives could be internally combined for specific SSL algorithms.

(d) SSL Interface to CSL

This defines the functions that may be provided by SSL for use by CSL. They are as follows:

SSLAllocRequest—The allocation requests generated and sent by CSL to SSL. These are classified as guaranteed, excess and system-optimizing.

SSLGetAllocRejects—Feedback provided from SSL to CSL to indicate the excess and system-optimizing slot allocations that could not be satisfied.

(e) SSL External Interface

The external interface of SSL consists of slot allocations sent to the capacity-requesting terminals as follows:

Resource Allocations: The resource (or more specifically slot) allocation is either applicable only for the next frame, or is applicable for all future frames/sub-frames till it is withdrawn. The mechanism for ensuring reliable transfer of resource allocations and de-allocations is system-specific.

(B) Data Structure and Definitions

An embodiment of the present invention, provides the data structures and definitions that may be used by RML, namely:

(a) Resource Descriptor

(b) Resource Plan

(c) Terminal Descriptor

(d) Request Cache

(e) Capacity Request

(a) Resource Descriptor

This database is used to maintain the current resources that have been provisioned at the NCC. Resources are identified by a specific hierarchy identifier, the desired QoS attributes, and the Slot-Pool from which the resource is to be apportioned. Each Resource Descriptor (ResDesc) entry in this database consists of the following fields:

ClusterId—Cluster identifier

UserId—User identifier (can be Default)

FlowId—Flow identifier (can be Default)

PoolId—Slot-Pool identifier

RFDesc—RF descriptor for composite representation of terminal RF characteristics (static and dynamic) like:

TermLoc—Terminal location (Beam Edge or Beam Center, can be Default)

TermRainFadeStatus—Terminal's rain-fade status (can be Default)

TermSizePowerCap—Size and power capabilities of the terminal (e.g., small low-RF power terminal or large high RF power terminal)

ReqInfo—Request parameters

IsReqPerm—Is the request Permanent (a CRA request will be generated) or Dynamic (requests will come from the User)?

ReqId—Capacity request identifier

Class—Traffic Class (e.g., Interactive, Background, Streaming)

BER—Desired bit error rate characteristics

CapParms—Capacity parameters

GuarRate—Minimum rate that is guaranteed for the Flow

PeakRate—Maximum rate for the Flow

Weight[MaxPrio]—Array of weights corresponding to all traffic handling priority levels. Weight represents the relative proportion in which bandwidth in excess of guaranteed should be allocated in comparison with other siblings at the same priority level.

TrafHandPrio—Traffic handling priority level (1 to MaxPrio) used for Leaf Classes; set to 1 for default Leaf Classes

DelayParms—Delay parameters

MaxDelay—Maximum allocation delay that can be tolerated

MaxDelayVar—Maximum allocation delay variance that can be tolerated

Outer-layer functions are responsible for system-specific and network-specific mapping of configuration information to the Resource Descriptor format. For instance, in a given network, Flows corresponding to end-users may be maintained in a “flow-spec” database. This database could identify all the Flows that correspond to an end-user, along with their defining characteristics such as “filtering-rules”, “QoS attributes”, etc. An external function, would process this individual Flow information with other databases such as one that maps RF descriptor and BER to a specific Slot-Pool Id. The Resource Descriptor database contains entries for (1) Cluster (mandatory for all entries); (2) Cluster/DefaultUser/Flow; (3) Cluster/User/DefaultFlow; and (4) Cluster/User/Flow. Cluster-specific records (1) and Cluster/DefaultUser/Flow (2) records are processed at initialization. User-specific records (3) and (4) are processed whenever a User logs into the network. Note that Cluster/User/Flow descriptors (4) can also be dynamically added to the resource descriptor database and acted upon after the User has logged on to the network. These descriptors are deleted from the resource descriptor database when the flow is explicitly deleted or when the User Logs out.

In the following algorithms it is assumed that the Resource Descriptor database has been pre-validated for self-consistency. For example, the sum of all the guaranteed rate requirements of all Cluster specific records for a specific PoolId should not exceed the total available capacity of the Slotpool. Similarly, the sum of all guaranteed rate requirements for Cluster/DefaultUser/Flow records should not exceed the specified guaranteed rate requirements of the Cluster.

(b) Resource Plan

This database tracks the capacity allocated to all the Slot-Pools in the system. Every Pool Descriptor (PoolDesc) entry in this database consists of the following fields:

PoolId—Slot-Pool identifier

CapPerFrame—Slot-Pool capacity in bits per second

FrameDuration—Frame duration in seconds

MinBitsPerSlot—Minimum bits that need to be allocated in a slot

PrioWeight[MaxPrio]—Array of weights. PrioWeight for a traffic handling priority level determines the share of excess bandwidth at Root level. MaxPrio corresponds to the Maximum number of traffic handling priority levels used in the system

(c) Terminal Descriptor

This database maintains the RF and location characteristics for each terminal. It is typically a subset of a larger terminal database. Each Terminal Descriptor (TermDesc) entry in this database consists of the following fields:

TermId—Terminal identifier

TermLoc—Terminal location (Beam Edge or Beam Center, can be Default)

TermRainFadeStatus—Terminal's rain-fade status (can be Default)

TermSizePowerCap—Size and power capabilities of the terminal (e.g., small low-RF power terminal or large high RF power terminal)

(d) Request Cache

For speed of access, RML maintains a Request Cache to rapidly find a Capacity.Class. It uses the Request Identifier and the User Identifier contained in a Capacity Request to lookup this cache. Each time a Capacity Class is created, a corresponding entry is made in the Request Cache. A Request Cache entry contains the following fields:

ReqId—Request identifier

UserId—User identifier

CapClass—Capacity Class identifier

(e) Capacity Request:

This defines the Capacity Request (CapReq) message used by RML and consists of the following fields:

UserId—User identifier

FlowId—Flow identifier

ReqId—Request identifier

Category—Rate (e.g., Constant Rate Request—CRR or Dynamic Rate Request—DRR) or Volume (e.g., Dynamic Volume Request—DVR)

IsReqIncr—Flag to indicate whether the Capacity Request is Absolute or Incremental

MaxAllocTime—Maximum time by which capacity allocation is useful

GuarReq—Guaranteed capacity requested (in bits/sec if Category is Rate, in bits if Category is Volume)

PeakReq—Peak capacity requested (in bits/sec if Category is Rate, in bits if Category is Volume)

SysSpecificData—System-specific data that is transparently provided to the Slot Scheduler

(C) Events

The RML design may be represented via the actions taken by RML in response to external input triggers or events as described below.

(a) RMLInitialization
LOCAL VARIABLES
RESDESC
TREE
CLUSTERCLASS
DEFUSERCLASS
FLOWCLASS
DEFFLOWCLASS
## DEFAULT CLUSTER ASSUMED TO BE INCLUDED IN THE RESOURCE DESCRIPTOR DATABASE

FOR (each PoolDesc in the Resource Plan database)

Tree:=CSLCreateCapacityTree (PoolDesc.PoolId, PoolDesc.CapPerFrame, PoolDesc.FrameDuration, PoolDesc.MinBitsPerSlot, PoolDesc.PrioWeight [MaxPrio])

## Search for Cluster specific records that correspond to default flow (User is default)

FOR (each ResDesc in the Resource Descriptor database)

IF (ResDesc.PoolId IS EQUAL TO PoolDesc.PoolId AND ResDesc.UserId IS EQUAL TO Default AND ResDesc.FlowId IS EQUAL TO Default)

ClusterClass:=CSLAddCapacityClass (Tree, Tree.RootClass, ResDesc.CapParms, ResDesc. DelayParms, ResDesc.TrafHandPrio, PreConfigured)

## Save Cluster Class Pointer for the specific Cluster

SetClusterClass (ResDesc.ClusterId, ResDesc. PoolId, ClusterClass)

## Create Default Classes for Children (no capacity allocated initially)

## Catch all Class for Users with no defined resources

DefUserClass:=CSLAddCapacityClass (Tree, ClusterClass, NULL, NULL, 0, AutoIncrement)

SetDefUserClass (ResDesc.ClusterId, ResDesc. PoolId, DefUserClass)

DefFlowClass:=CSLAddCapacityClass (Tree, DefUserClass, NULL, NULL, 1, AutoIncrement)

SetDefUserDefFlowClass (ClusterClass, DefFlowClass)

ENDIF

ENDFOR
## SEARCH FOR CLUSTER-SPECIFIC SPECIFIC FLOW (NON-DEFAULT) RECORDS (USER IS DEFAULT)
FOR (EACH RESDESC IN THE RESOURCE DESCRIPTOR DATABASE)

IF (ResDesc.PoolId IS EQUAL TO PoolDesc.PoolId AND

ResDesc.UserId IS EQUAL TO Default AND

ResDesc.FlowId IS NOT EQUAL TO Default)

DefUserClass:=GetDefUserClass (ResDesc.ClusterId, ResDesc.PoolId)

FlowClass:=AddUserFlow (DefUserClass, DefaultTerm, ResDesc)
ENDIF
ENDFOR
ENDFOR

(b) RMLUserLogon (UserId)
ADDUSER (USERID, GETTERMID (USERID)) ## TERMINAL RAIN-FADE STATUS SET A-PRIORI

(c) RMLUserLogoff (UserId)
DELETEUSER (USERID)

(d) RMLAddFlow (ResDesc)

Local Variables

UserClass

ClusterId

ClusterClass

FlowClass

TermId

Tree

## Note that temporary entries are made in the resource descriptor database

Tree:=GetCapTreeFromPoolId (ResDesc.PoolId)

## Retrieve pointer to the User Class (corresponding to the user in the ResDesc record); ## Note that User Class may not exist

UserClass:=GetUserClass (ResDesc.UserId, ResDesc. PoolId)

TermId:=GetTermId (ResDesc.UserId)

IF (ResDesc.FlowId IS NOT EQUAL TO Default)

IF (UserClass IS NOT NULL)

FlowClass:=AddUserFlow (UserClass, TermId, ResDesc)

ELSE

ClusterClass:=GetClusterClass (ResDesc.ClusterId, ResDesc.PoolId)

UserClass:=CSLAddCapacityClass (Tree, ClusterClass, NULL, NULL, 0, AutoIncrement)

FlowClass:=AddUserFlow (UserClass, TermId, ResDesc)

IF (FlowClass IS NOT NULL)

SetUserClass (ResDesc.UserId, ResDesc.PoolId, UserClass)

## Also create DefFlowClass below the newly created UserClass

DefFlowClass:=CSLAddCapacityClass (Tree, UserClass, NULL, NULL, 1, AutoIncrement)

SetRequestCache (ResDesc.UserId, DefaultReqId, DefFlowClass)

ELSE

CSLDeleteCapacityClass (Tree, UserClass)

ENDIF

ENDIF

ELSE ## Flow Class is Default-Flow Class for specific User

## Does User Class exist (was there a standalone User Resource Descriptor?)

IF (UserClass IS NULL)

ClusterClass:=GetClusterClass (ResDesc.ClusterId, ResDesc.PoolId)

UserClass:=CSLAddCapacityClass (Tree, ClusterClass, NULL, NULL, 0, AutoIncrement)

SetUserClass (ResDesc. UserId, ResDesc. PoolId, UserClass)

ENDIF

DefFlowClass:=CSLAddCapacityClass (Tree, UserClass, NULL, NULL, 1, AutoIncrement)

SetRequestCache (ResDesc.UserId, DefaultReqId, DefFlowClass)

ENDIF

(e) RMLDeleteFlow (ResDesc)

Local Variables

FlowClass

UserClass

UserId

FlowClass:=LookupRequestCache (ResDesc.UserId, ResDesc.Req Info.ReqId)

UserClass:=GetParent (FlowClass)

UserId:=GetClassId (UserClass)

IF (UserId IS EQUAL TO ResDesc.UserId) ## Is Flow Class exclusive to this User?

DeleteUserFlow (FlowClass)

IF (User Class type is AutoIncrement AND only has a Default Flow Class) THEN

DeleteUser (UserId)

ENDIF

ENDIF

(f) RMLCapacityRequest (CapReq)

Local Variables

LeafClass

Tree

LeafClass:=LookupRequestCache (CapReq.UserId, CapReq.ReqId)

Tree:=GetCapTreeFromClass (LeafClass)

CSLAddCapacityRequest (Tree, LeafClass, CapReq)

(g) RMLTermRainFadeChange (TermId)

Local Variables

UserId

FOR (each User at TermId)

DeleteUser (UserId)

ENDFOR

Update terminal RF Characteristics to reflect change in rain fade status

FOR (each User at TermId)

AddUser (UserId)

## Attempt to add User-specific resource descriptors (if configured in the ## Resource Descriptor database) to match the ## updated RF characteristics. If none can be setup, the system could optionally

## logoff User. Similarly, if no Users can be handled, system could optionally

## logoff terminal

ENDFOR

(h) RMLSchedulingIntervalSignal
LOCAL VARIABLES
TREE
## NOTE THAT WE NEED TO PERFORM ALLOCATION OF GUARANTEED CAPACITY FOR ALL TREES

## before performing allocation of Excess Capacity and System-Optimizing Capacity.
SSLSTARTSCHEDULINGCYCLE ( )

FOR (each PoolDesc in Resource Plan database)

Tree:=GetCapTreeFromPoolId (PoolDesc.PoolId)

CSLStartSchedulingCycle (Tree)

ENDFOR

FOR (each PoolDesc in Resource Plan database)

Tree:=GetCapTreeFromPoolId (PoolDesc.PoolId)

CSLScheduleGuaranteedCapacity (Tree)

ENDFOR

FOR (each PoolDesc in Resource Plan database)

Tree:=GetCapTreeFromPoolId (PoolDesc.PoolId)

CSLScheduleExcessCapacity (Tree) ## For all Traffic Priority levels

ENDFOR

FOR (each PoolDesc in Resource Plan database)

Tree:=GetCapTreeFromPoolId (PoolDesc.PoolId)

CSLScheduleSystemOptimizingCapacity (Tree)

ENDFOR

SSLScheduleSlotCycle ( )

FOR (each PoolDesc in Resource Plan database)

Tree:=GetCapTreeFromPoolId (PoolDesc. PoolId)

CSLStopSchedulingCycle (Tree) ## Handles requests rejected by SSL

ENDFOR

SSLStopSchedulingCycle ( )

(D) Functions

This section describes the internal functions used by RML in Example 1.

(a) AddUser (UserId, TermId)

Local Variables

Tree

ResDesc

TermRFDesc

ClusterClass

DefFlowClass

UserClass

FlowClass

ClusterId

IsUserPreConfigured

IsFlowPreConfigured

IsUserPreConfigured:=NO

IsFlowPreConfigured:=NO

TermRFDesc:=GetTermRFDesc (TermId)

ClusterId:=GetClusterId (UserId)

## Locate Resource Descriptor entry for User with current

RF characteristics

FOR (each ResDesc in the Resource Descriptor database)

IF (ResDesc.ClusterId IS EQUAL TO ClusterId AND ResDesc.UserId IS EQUAL TO UserId AND ResDesc.FlowId IS EQUAL TO Default AND ResDesc.RFDesc IS EQUAL TO TermRFDesc)

Tree:=GetCapTreeFromPoolId (ResDesc.PoolId)

ClusterClass:=GetClusterClass (ResDesc.ClusterId, ResDesc.PoolId)

IF (CSLIsCapacityAvail (Tree, ClusterClass, ResDesc.CapParms) AND SSLIncrGuarTermCap (TermId, ResDesc.CapParms.GuarRate))

UserClass:=CSLAddCapacityClass (Tree, ClusterClass, ResDesc.CapParms, ResDesc.DelayParms, 0, PreConfigured)

SetUserClass (ResDesc.UserId, ResDesc.PoolId, UserClass)

DefFlowClass:=CSLAddCapacityClass (Tree, UserClass, NULL, NULL, ResDesc.TrafHandPrio, AutoIncrement)

SetRequestCache (ResDesc.UserId, DefaultReqId, DefFlowClass)

IsUserPreConfigured:=YES

ENDIF

ENDIF

ENDFOR

## Locate Resource Descriptor entries for User-specific Flows with current RF characteristics

FOR (each ResDesc in the Resource Descriptor database)

IF (ResDesc.ClusterId IS EQUAL TO ClusterId AND ResDesc.UserId IS EQUAL TO UserId AND ResDesc.FlowId IS NOT Default AND ResDesc.RFDesc IS EQUAL TO TermRFDesc)

UserClass:=GetUserClass (UserId, ResDesc.PoolId)

IF (UserClass IS NOT NULL)

FlowClass:=AddUserFlow (UserClass, TermId, ResDesc)

IF (FlowClass IS NOT NULL)

IsFlowPreConfigured:=YES

ENDIF

ELSE

ClusterClass:=GetClusterClass (ResDesc.ClusterId, ResDesc.PoolId)

UserClass:=CSLAddCapacityClass (Tree, ClusterClass, NULL, NULL, 0, AutoIncrement)

FlowClass:=AddUserFlow (UserClass, TermId, ResDesc)

IF (FlowClass IS NOT NULL)

SetUserClass (ResDesc.UserId, ResDesc.PoolId, UserClass)

DefFlowClass:=CSLAddCapacityClass (Tree, UserClass, NULL, NULL, 1, AutoIncrement)

SetRequestCache (ResDesc.UserId, DefaultReqId, DefFlowClass)

IsFlowPreConfigured:=YES

ELSE

CSLDeleteCapacityClass (Tree, UserClass)

ENDIF

ENDIF

ENDIF

ENDFOR

## If either a User-specific or User Flow-specific Class has been created, then exit

IF (IsUserPreConfigured IS YES OR IsFlowPreConfigured IS YES)

EXIT

ENDIF

## Update Request Cache if User has no entry in the database; locate default user

FOR (each ResDesc in the Resource Descriptor database)

IF (ResDesc.ClusterId IS EQUAL TO ClusterId AND ResDesc.UserId IS EQUAL TO Default AND ResDesc.FlowId IS EQUAL TO Default AND ResDesc.RFDesc IS EQUAL TO TermRFDesc)

## Look for Cluster Id for the specific Pool ClusterClass:=GetClusterClass (ClusterId, ResDesc.PoolId)

DefFlowClass:=GetDefUserDefFlowClass (ClusterClass, ResDesc.PoolId)

SetRequestCache (UserId, DefaultReqId, DefFlowClass)

ENDIF

ENDFOR

(b) AddUserFlow (UserClass, TermId, ResDesc)

Local Variables

FlowClass

Tree

Tree:=GetCapTreeFromPoolId (ResDesc.PoolId)

## Is Class capacity available and can terminal be assigned additional slots?

IF (CSLIsCapacityAvail (Tree, UserClass, ResDesc.CapParms) AND (UserClass.Type is Pre-Configured OR SSLIncrGuarTermCap (TermId, ResDesc.CapParms.GuarRate)) THEN

FlowClass:=CSLAddCapacityClass(Tree, UserClass, ResDesc.CapParms, ResDesc.DelayParms, ResDesc.TrafHandPrio, PreConfigured)

## For Permanent request type, add a CRA capacity request

IF (ResDesc.ReqInfo.IsReqPerm IS TRUE)

CSLAddCapacityRequest (Tree, FlowClass, MakeCRAReq (ResDesc))

ENDIF

SetRequestCache (ResDesc.UserId, ResDesc.ReqInfo.ReqId, FlowClass)

RETURN (FlowClass)

ELSE

## Notify management layer about Flow addition failure

RETURN (NULL)

ENDIF

(c) DeleteUser (UserId)

Local Variables

PoolDesc

UserClass

## Delete all Flows for the User (including Default Flow)

## Clear the Request Cache entries for the User Flows

## Delete User Class and delete Request Cache entry for Default Flow

FOR (each PoolDesc in Resource Plan database)

UserClass:=GetUserClass (UserId, PoolDesc.PoolId)

IF (UserClass IS NOT NULL)

IF (GetClassId (UserClass) IS EQUAL TO UserId)

FOR (each Flow belonging to this User)

DeleteUserFlow (FlowClass)

ENDFOR

ENDIF

IF (UserClass Type is Pre-Configured) THEN ## Capacity was specified on a User basis

SSLDecrGuarTermCap (TermId, GetCapParms (UserClass))

ENDIF

CSLDeleteCapacityClass (Tree, UserClass)

## Also Clear User Class pointer for the User Id in the specific Pool

ENDIF

ENDFOR

ClrRequestCache (UserId, DefaultReqId)

(d) DeleteUserFlow (FlowClass)

Local Variables

Tree

UserClass

UserId

TermId

UserClass:=GetParent (FlowClass)

UserId:=GetClassId (UserClass)

TermId:=GetTermId (UserId)

Tree:=GetCapTreeFromClass (FlowClass)

CapParms:=GetClassCapParms (FlowClass)

ReqId:=GetClassReqId (FlowClass)

IF (UserClass.Type is AutoIncrement) THEN

## otherwise this will be done in DeleteUser

SSLDecrGuarTermCap (TermId, CapParms)

ENDIF

CSLDeleteCapacityClass (Tree, FlowClass)

ClrRequestCache (UserId, ReqId)

(E) Utility Routines

This section of Example 1 describes possible utility routines used by RML.

(a) Routines for User and Terminal Characteristics

GetTermId (UserId)—Looks up TermId that corresponds to specified UserId

GetTermRFDesc (TermId)—Gets the RF descriptor (TermLoc, TermRainFadeStatus, and TermSizePowCap) for the specified terminal.

GetClusterId (UserId)—Looks up ClusterId that corresponds to specified UserId

(b) Routines for Capacity Class and Capacity Request

GetCapTreeFromPoolId (PoolId)—Gets a handle to the capacity tree given the Slot-Pool Id

GetCapTreeFromClass (Class)—Gets a handle to the capacity tree given the Capacity Class

GetParent (Class)—Gets parent Class for the given Capacity Class

GetClassId (Class)—Gets the Id from Class (e.g. UserId from UserClass, FlowId from FlowClass)

GetClassCapParms (Class)—Gets Capacity Parameters for the Capacity Class

GetClassReqId (Class)—Gets the Request Id for the given Capacity Class

MakeCRAReq (ResDesc)—Create Continuous Rate Assignment request from the indicated Class

SetClusterClass (ClusterId, PoolId, ClusterClass)—Sets Cluster Capacity Class (pointer) in the indicated pool for the specified Cluster

GetClusterClass (ClusterId, PoolId)—Returns Cluster Capacity Class corresponding to specified ClusterId and PoolId

GetUserClass (UserId, PoolId)—Gets User Capacity Class in the indicated Slot-Pool for specified User

SetUserClass (UserId, PoolId, UserClass)—Sets User Capacity Class (pointer) in the indicated Slot-Pool for the specified User

SetDefUserClass (ClusterId, PoolId, DefUserClass)—Sets Default User Capacity Class (pointer) in the indicated Slot-Pool and Cluster

GetDefUserClass (ClusterId, PoolId)—Gets the Default User Capacity Class in the indicated Slot-Pool and Cluster

SetDefUserDefFlowClass (ClusterClass, DefFlowClass)—Saves the Default Flow Class for the Default User under a Cluster

GetDefUserDefFlowClass (ClusterClass)—Gets Default Flow Class for the Default User under the specified Cluster

(c) Routines for Request Cache

SetRequestCache (UserId, ReqId, Class)—Adds an entry to the request cache with key (UserId, ReqId) and data (Class)

LookupRequestCache (UserId, ReqId)—Returns cache entry (Leaf Class) corresponding to key (UserId, ReqId)

ClrRequestCache (UserId, ReqId)—Clears an entry in the request cache corresponding to key (UserId, ReqId)

### Example 2

Example 2 provides for the application of an embodiment of the present invention in a DVB-RCS Satellite Network. In particular, this embodiment of the invention provides for DVB-RCS Specific Mapping. References include “Digital Video Broadcasting (DVB)—Interaction channel for satellite distribution system”—ETSI EN 301 790 v1.3.1 (2003-03), and “Digital Video Broadcasting (DVB)—Interaction channel for satellite distribution system—Guidelines for the use of EN 301 790”, ETSI TR 101 790, v1.2.1 (2003-01).

A DVB-RCS network is capable of optionally authorizing and authenticating end-users or end-user hosts that are beyond a Return Channel Satellite Terminal (RCST). Accordingly it is feasible to support the following hierarchy and SLA options:

End-User (all Flows—Default Flow)
END-USER AND SPECIFIC FLOW

RCST (all Flows—Default Flow)
RCST AND SPECIFIC FLOW

Note that these SLA arrangements are hierarchically arranged below a Cluster or Default Cluster within each pool. DVB-RCS specific mapping is provided to transform messages received from an RCST to the format used by the RML architecture. This section of Example 2 highlights the mapping strategies that need to be employed vis-à-vis these messages. Details of how User/RCST and Flow databases are handled are not described, but couId be implemented without undue experimentation by one of ordinary skill in the art in light of the present specification.

(A) Mapping of Capacity Requests

Capacity requests are received from RCSTs (which are identified by their GroupId and LogonId). The Capacity Request message in DVB-RCS has the following fields: Category; ChannelId; and Value (and its scaling factor). The four bit ChannelId is used to differentiate channel requests from an RCST. The DVB-RCS specification currently supports three “return channel” capacity request types from an RCST. These correspond to:

Rate based Dynamic Capacity (RBDC): This is used for variable rate traffic which can tolerate some delay jitter like ATM ABR traffic. It has an associated parameter that indicates the desired rate (in multiples of 2 Kbit/s)

Volume Based Dynamic Capacity (VBDC): This is used only for traffic that can tolerate delay jitter, such as ATM UBR traffic or best effort IP traffic. It has an associated parameter that indicates the incremental desired volume (in multiples of payload size, which is 53 bytes in case of ATM and 188 bytes in case of MPEG2-TS)

Absolute VBDC (AVBDC): This is also used only for traffic that can tolerate delay jitter, such as the ATM UBR traffic or best effort IP traffic. It has an associated parameter that indicates the desired absolute volume (in multiples of payload size).

As stated earlier, there are multiple SLA options that can be supported for an RCST. Accordingly, for every RCST, a mapping is maintained which maps the incoming ChannelId to a UserId and a ReqId. The mapping of DVB-RCS specific requests follows the format given below:

CapReq.UserId:=GetRCSUser (RCSGroupId, RCSLogonId, RCSCapReq.ChannelId)

CapReq.ReqId:=GetRCSReq (RCSGroupId, RCSLogonId, RCSCapReq.ChannelId)

IF (RCSCapReq.Category IS EQUAL TO RBDC)

CapReq.Category:=Rate

CapReq.IsReqInc:=FALSE

CapReq.MaxAllocTime:=MaxRefreshTime [1600 msec]

CapReq.Rate:=RCSCapReq.Value*RateMultiplier

ELSEIF (RCSCapReq.Category IS EQUAL TO VBDC)

CapReq.Category:=Volume

CapReq.IsReqInc:=TRUE

CapReq.MaxAllocTime:=Infinite

CapReq.Volume:=RCSCapReq.Value*VolumeMultiplier

ELSEIF (RCSCapReq.Category IS EQUAL TO AVBDC)

CapReq.Category:=Volume

CapReq.IsReqInc:=FALSE

CapReq.MaxAllocTime:=Infinite

CapReq.Volume:=RCSCapReq.Value*VolumeMultiplier

ENDIF

(B) User Logon and Logoff

An aspect of the present invention envisions two scenarios for handling User Logon. In the first case, capacity management is being provided only at the level of the RCST. Accordingly, the completion of the Return Link Acquisition sequence (CSC/ACQ/SYNC) results in a single User Logon request (where the User corresponds to the RCST). User or RCST Logoff in this case happens when the RCST loses synchronization. In the second case, capacity management is being provided on an end-user basis and so User Logon is activated after the completion of the end-user authentication sequence (typically via RADIUS). In the event that individual end-user authentication is not being supported, the successful RCST Return Link Acquisition sequence generates User Logon messages for all end-users whose capacity is being individually managed. User Logoff may be indicated by the RCST by sending an SNMP trap to the NCC. User Logoff is also assumed to have taken place if the RCST loses synchronization or becomes unreachable.

(C) Terminal Rain-fade

Regarding terminal rain-fade, DVB-RCS does not define an explicit rain-fade status message from the RCST. This message is internally generated within the NCC (in conjunction with other counter-measures such as power control that can be used).

1. A system comprising a resource management architecture that meets the requirements of supporting hierarchical SLAs with QoS commitments in a multi-frequency TDMA based wireless environment, wherein said architecture provides the capability of allocating resources to an end-user terminal, meeting end-user requirements selected from the group consisting of multitude of traffic Classes of service, traffic capacity parameters, traffic service quality, end-user terminal location within the coverage area, and dynamically changing propagation conditions.

2. The system of claim 1, wherein said resource management architecture enables a single end-user terminal to transmit bursts with multiple modulation types, symbol rates, and coding rates within a single TDMA frame.

3. The system of claim 1, wherein said resource management architecture is capable of supporting both static and dynamic capacity requirements; wherein said static requirements correspond to Users whose traffic characteristics are fixed for the duration of a session; wherein said dynamic requirements correspond to traffic flows that have variable, possibly bursty data transfer requirements; and wherein said architecture supports both rate and volume based capacity requests.

4. The system of claim 1, wherein said resource management architecture utilizes separate algorithms for capacity allocation and TDMA slot allocation; wherein said capacity scheduling algorithm is responsible for the allocation of the available capacity (in bits) in a TDMA frame; wherein said slot scheduling algorithm takes as inputs the allocations performed by the capacity scheduling algorithm and maps these to slots in the TDMA frame taking into consideration constraints associated with terminal characteristics; and wherein said algorithms, operate and optimize resources (capacity and slot) in an independent manner in order to achieve overall system optimization.

5. The system of claim 1, wherein said architecture provides capacity and QoS guarantees for Flows (end-user applications or Classes) or Users (all Flows); wherein said Users can either be user terminals or end-users/hosts behind user terminals; wherein capacity related parameters may consist of guaranteed capacity, peak capacity, traffic handling priority level, and weights relative to siblings; wherein said architecture provides for hierarchical arrangements; wherein Flow level guarantees are provided at a level below the User; wherein above the User level, a Cluster (corresponding to a collection of Users) level hierarchy can be defined; and wherein, additional hierarchies are also possible above the Cluster level.

6. The system of claim 1, wherein said resource management architecture manages available capacity as one or more Slot-Pools; wherein a single Slot-Pool corresponds to TDMA slots of a single modulation type, symbol rate, coding type and coding rate; and wherein the Slot-Pool may contain slots with different information lengths.

7. The system of claim 1, wherein said architecture comprises of three logical layers selected:
(a) a Resource Management Layer (RML) that provides procedures to map end-user traffic requirements to specific Slot-Pools and Capacity Classes and is responsible for the overall scheduling of the capacity and slot allocation algorithms,
(b) a Capacity Scheduling Layer (CSL) that provides for the hierarchical allocation of capacity in a manner similar to that performed by packet TDM schedulers, wherein there is one CSL for each Slot-Pool, and
(c) a Slot Scheduling Layer (SSL) that provides for the overall scheduling of time-slots within a TDMA frame taking as input capacity allocations from one or more CSLs.

8. The system of claim 7, wherein said RML handles creation and deletion of one or more Capacity Classes; wherein said Capacity Class corresponds to an entity for which specific capacity guarantees are to be provided; wherein said Capacity Class is associated with guaranteed and peak rates, traffic handling priority level, as well as a relative weighting vis-à-vis its siblings; wherein said Capacity Class can be either an Interior Class or a Leaf Class; wherein said Leaf Class corresponds to Flows.

9. The system of claim 7, wherein an internal “Resource Descriptor” database is used to instantiate the Capacity Classes that need to be provisioned; wherein each entry in said database can be identified by Cluster, User and Flow; wherein User and Flow can be designated as Default; wherein each entry in said database lists the QoS parameters associated with the Class, as well as the identifier for the Slot-Pool in which the resources are to be allocated; wherein each entry in said database contains a unique Request Id that is to be used to distinguish between dynamically received capacity requests from a User as well as to map the incoming requests to a specific Leaf Class; and wherein each entry in said database contains the RF characteristics for the terminal associated with the User.

10. The system of claim 7, wherein said RML maintains a “Request Cache” that provides an efficient means of mapping <User Id, Request Id> to the corresponding Leaf Class; wherein an entry is added to said cache every time a Leaf Class (e.g., corresponding to a Flow) is added to a Capacity Tree; and wherein said cache is used for fast access of the Leaf Class to which the incoming capacity requests are attached.

11. The system of claim 1, wherein in case of Users with no explicit provisioned capacity requirements, Default User and Default Flow Classes are automatically created; wherein a Default Class is always allocated capacity equal to the difference between the capacity provisioned to its parent and the sum of provisioned capacity of all its siblings; and wherein Default User Class and the corresponding Default Flow Class are created when a Capacity Class for a provisioned Cluster is created.

12. The system of claim 7, wherein on the addition of a User record, RML performs admission control to determine whether the desired capacity parameters can be satisfied; wherein if so, a User Capacity Class is created as a child of the Class corresponding to the User's Cluster; and wherein a Default Flow Class for said User will also be created.

13. The system of claim 7, wherein upon the addition of a User-specific Flow record, RML may perform admission control to determine whether the desired capacity parameters can be satisfied; wherein if so, a User Capacity Class may be created as a child of the Class corresponding to the User's Cluster (if no User-specific Class has been created previously); and wherein a Flow Class for the new User-specific Flow may also be created.

14. The system of claim 13, wherein for User-specific Flows that are provisioned with a continuous rate assignment, a capacity request with the associated capacity parameters may be automatically generated and attached to the corresponding Flow Class; and wherein this request may be treated as perpetual as long as the User remains active.

15. The system of claim 7, wherein upon the presence of a Cluster-specific Flow record, RML may create a Capacity Class for the specified Flow as a child of the Default User Class.

16. The system of claim 7, wherein upon the addition of a User for whom no User or User-specific Flow records exist, the Request Cache may be updated to point to the Default Flow Class under the Default User Class for the parent Cluster.

17. The system of claim 7, wherein said RML is capable of re-mapping active resource descriptors to different Slot-Pools and Classes based on changes to propagation environment (e.g., rain-fade in satellite environment); wherein upon the receipt of a change in rain-fade status for a terminal, RML may delete all entries from current Slot-Pool for all the Users and if provisioned their Flows, wherein said RML may then attempt to create alternative Capacity Classes in a different Slot-Pool (if configured) in the resource descriptor database; and wherein said RML may also update the Request Cache to point to the new Capacity Classes.

18. The system of claim 1, wherein said architecture is designed to receive dynamic capacity requests in an unsynchronized manner, while scheduling capacity and slots in a synchronized manner; wherein the synchronized allocation of capacity is performed even if the system allows for immediate responses to capacity requests and the periodicity over which the scheduling is performed is referred to as the “Scheduling-Interval”, which typically corresponds to the duration of one TDMA frame; and wherein, optionally, said system performs scheduling on sub-frame boundaries.

19. The system of claim 7, wherein said CSL algorithm is designed to allocate available capacity in three cycles—guaranteed, excess, and system-optimizing; wherein said guaranteed capacity corresponds to the minimum value that is configured for the Class and cannot be denied allocation; wherein said excess capacity allocation represents an equitable distribution of available capacity to eligible Classes based on established service level agreements and priorities; and wherein said system-optimizing capacity allocation cycle represents a small amount of additional allocations (beyond the available capacity in the pool), such that SSL can fully pack a TDMA frame.

20. The system of claim 7, wherein said RML as part of adding a new Capacity Class may also check the feasibility of supporting its guaranteed capacity requirement with the SSL algorithm; and wherein said SSL algorithm may maintain a “contingency” slot-schedule (which is able to ensure that all guaranteed capacity requests can be met), and may use the contingency slot-schedule as a starting point in the event that it cannot schedule all the guaranteed allocations when performing the scheduling in an optimal manner.

21. The system of claim 7, wherein said RML performs allocation scheduling on every Scheduling Interval with at least one of the following steps:
(a) Start Slot Scheduling and Capacity Scheduling (initialization);
(b) Invoke Capacity Scheduling algorithm for the guaranteed cycle for each Slot-Pool;
(c) Invoke Capacity Scheduling algorithm for the excess cycle for each Slot-Pool;
(d) Invoke Capacity Scheduling algorithm for the system-optimizing cycle for each Slot-Pool;
(e) Invoke Slot-Scheduler (common across all Slot-Pools); and
(f) Stop Capacity Scheduling and Slot Scheduling for this Scheduling Interval; and wherein, optionally, some CSL/SSL implementations combine the Start/Stop Scheduling steps with the Scheduling step.

22. The system of claim 21, wherein said CSL is system independent and provides for the hierarchical allocation of capacity within each Slot-Pool; and wherein said CSL allocates available capacity in accordance with the Capacity requirements (e.g., guaranteed rate, peak rate, weight) and traffic handling priority of all configured Capacity Classes (Interior and Leaf) and all active Capacity Requests.

23. The system of claim 21, wherein said SSL is system-specific, and may provide for common allocation of resources across all Slot-Pools; wherein multiple slot allocations can be combined into a single TDMA slot subject to the constraints of the supplied frame layout and terminal blocking; wherein a single SSL may schedule capacity from multiple CSLs; and wherein said SSL may consider the guaranteed allocation from all Slot-Pools, followed by excess allocations from all Slot-Pools, followed by the system-optimizing allocations from all Slot-Pools to pack the scheduling interval frame.

24. The system of claim 1, wherein said resource management architecture is capable of supporting systems where the frame composition can be dynamically varied (i.e., where the composition of time-slots can change dynamically on a frame-by-frame basis), wherein a background algorithm may modify the capacity that is logically allocated to each Slot-Pool; wherein in computing the capacity value, the algorithm may take into consideration the current demand from all Slot-Pools; wherein the modification to Slot-Pool allocated capacity can be done at a slower rate (e.g., every 10 seconds) or can be done on a frame-by-frame basis; wherein the algorithm may ensure that the guaranteed or minimum capacity requirements that have been committed to Users and User Flows in each Slot-Pool are always met.

25. The system of claim 24, wherein example of said system is IEEE 802.16.

26. The system of claim 1, wherein said system is applied to an ETSI DVB-RCS satellite network by mapping an RCST's Group Id, Logon Id and Channel Id received in incoming capacity request messages to a User Id and Request Id; and wherein said method allows capacity parameters to be defined for end-users, end-user Flows, RCST, and RCST Flows.
